(19) United States
(12) Patent Application Publication
(10) Pub. No.: US 2012/0226525 A1
(43) Pub. Date: Sep. 6, 2012

(54) METRIC DRIVEN BEHAVIOR AND PRESENTATION OF GOALS

(75) Inventors: Manbhawan Prasad, Hyderabad (IN); Nimisha Saboo, Hyderabad (IN); Apoorvi Kapoor, Hyderabad (IN); Sharath Tejasvi, Hyderabad (IN); Raju Kulkarni, Hyderabad (IN); Hemant Gaur, Hyderabad (IN); Mahesh Paliath, Hyderabad (IN); Ashwani Jindal, Hyderabad (IN); Hariprasad Sanapoori, Hyderabad (IN); Vinay Kumar, Hyderabad (IN); David Shutt, Seattle, WA (US); Manoj Shende, Hyderabad (IN)

(73) Assignee: MICROSOFT CORPORATION, Redmond, WA (US)

(21) Appl. No.: 13/040,529

(22) Filed: Mar. 4, 2011

(51) Int. Cl. G06Q 10/00

(52) U.S. Cl. 705/7.36

(57) ABSTRACT

A Customer Relationship Management (CRM) system enables tracking of multiple types of goals within the system employing the same construct, whose look-and-feel and behavior may be dynamically modified based on different user defined metrics. Actuals against the goals are computed by the system based on source entity definitions in metrics and user defined dimensions with filters.

### BACKGROUND

Customer Relationship Management (CRM) is a set of strategies and programs for managing an organization's interactions with customers, clients, sales prospects, and similar entities. It involves using technology to organize, automate, and synchronize business processes such as sales activities, marketing activities, customer service, technical support, and comparable ones. With an overall goal of finding, attracting, and winning new clients, nurturing and retaining existing clients, enticing former clients back, and reducing costs of marketing and client service, CRM describes an organization-wide business strategy including customer-interface departments as well as other departments. Increases in revenue, higher rates of client satisfaction, and savings in operating costs are some of the benefits measurable of CRM to an enterprise.

CRM applications employ different dimensions and metrics to track, measure, and present business processes. For example, goals may be computed based on rolled up dimensions as estimates and actuals, and then compared to determine a person or team's performance. However, maintenance of different types of goals like revenue, number of cases, number of product units, etc. in an organization may become challenging if the organization uses different constructs for each of these. Also, a computation of actuals mechanism may become complex and difficult to maintain across different types of goals in multiple dimensions like territories, products, accounts, etc. Furthermore, monitoring of goals of different types and in multiple dimensions may be substantially complicated when an organization uses different constructs and implementation for different types and dimensions.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a CRM system that enables tracking of multiple types of goals within the system employing the same construct, whose look-and-feel and behavior may be dynamically modified based on different user defined metrics. Actuals against the goals may be computed by the system based on source entity definitions in metrics and user defined dimensions with filters.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates main components of a CRM system capable of metric driven behavior and presentation of goals;

FIG. 2 illustrates an example rollup process according to some embodiments;

FIG. 3 is a block diagram illustrating an example rollup process according to embodiments;

FIG. 4 is a screenshot of an example user interface for specifying parameters in a CRM system according to embodiments;

FIG. 5 is a screenshot of another example user interface for specifying parameters in a CRM system;

FIG. 6 is a networked environment, where a system according to embodiments may be implemented;

FIG. 7 is a block diagram of an example computing operating environment, where embodiments may be implemented; and

FIG. 8 illustrates a logic flow diagram for a process of adjusting behavior and presentation of goals based on metrics in a CRM system according to embodiments.

### DETAILED DESCRIPTION

As briefly described above, goals may be computed based on different dimensions modeled as a rollup query and metric definition in a CRM system according to embodiments. The actuals may then be rolled up the hierarchy. The goals may be represented in different dimensions using the metric. Moreover, the same construct may be employed for goal representation, which may change its behavior and look-and-feel based on metric definition dynamically.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for enabling metric driven behavior and presentation of goals in a CRM system. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

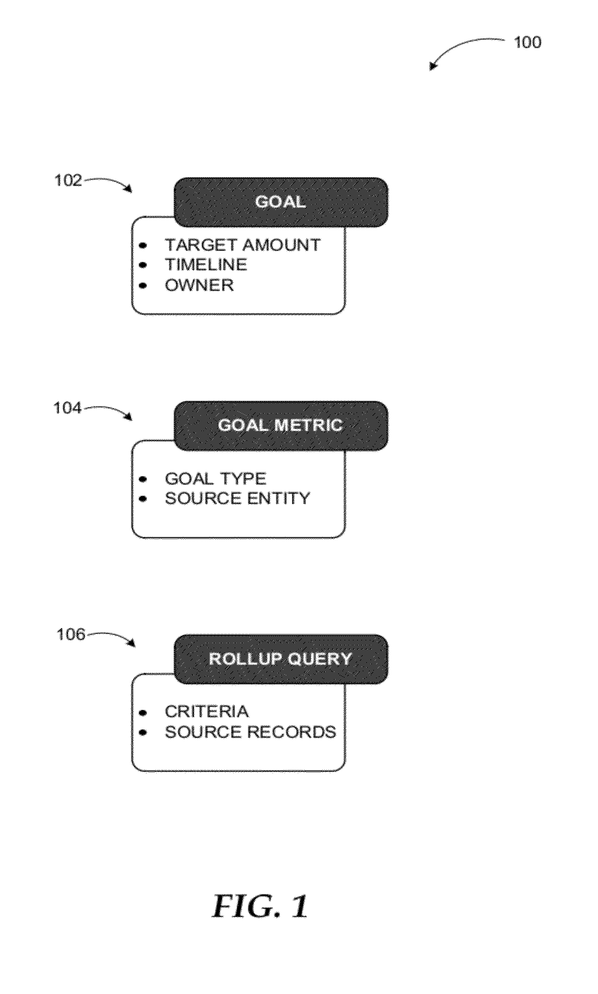

Referring to FIG. 1, main components of a CRM system capable of metric driven behavior and presentation of goals are illustrated on diagram 100. The components shown in FIG. 1 are for illustration purposes. Embodiments may be implemented employing additional components.

A goal management mechanism of a CRM application according to embodiments may employ goal 102, goal metric 104, and rollup query 106 as entities. These entities capture goal setting, rollups, and progress against the goals. Goal management addresses the process of defining and assigning targets to individuals (or teams) on different perspectives such as product lines, territories, and comparable ones (e.g., sales targets). Goal management also establishes expectations for preparing and motivating activities such as sales to achieve over the duration of the fiscal periods as well as custom periods.

The goal setting process may follow a top to down approach, and roll up dimensions such as revenues. A manager may define the overall goals for the entire organization and allocate them downwards. A supervisor reporting to the manager may analyze historical records, market(s), and budget(s) to define a goal for a group within the organization. The goal for each group may be divided and allocated downward to the organization members in a hierarchy. This is a commonly used and followed method in sales organizations. In large organizations, overall goal for the company may be decided by taking inputs from various division holders. For example, regional sales managers may be asked to define the goals for their regions, which are then taken into account in defining overall organization goals.

Different organizations follow different types of structure for managing goals within each organization, however. For example, some organizations may set goals for territories, product lines, etc. In most cases, a manager's goal and employee goals are connected though, so that revenue or other metrics can flow up. To support complex goals, which are found in many organizations, a CRM system needs to be flexible and customizable to suit the different needs.

Goal 102 defines target amount, time period, owner, and a parent goal it is connected to. Goal 102 may also present the data which rolls up as actuals and estimates against the target. High level goal entity attributes may include target, accountable person for meeting the target, the time period to achieve the goal, actual/in-progress/custom rollup fields, and child goals. The system may calculate the actuals and fill the rollup fields based on rollup queries and metric definition. Actuals from child goals may be rolled up to their respective parent goal. Goal 102 may also have a goal metric and rollup criteria (rollup queries for different rollup fields such as “Actual”, “In-progress”).

Goal metric 104 may specify the definition of the goal type and rollup rules for actuals and estimates. Goal type fields may include a fiscal amount, an integer amount, a decimal amount, a count, or similar variables. A rollup query 106 may define records that are considered for rolling up actual/in-progress/custom fields against the goal. Some examples of rollup queries may include, but are not limited to, territory, product, subject for product line, account, etc. A rollup query may also be a custom query based on any out of the box or custom entities.

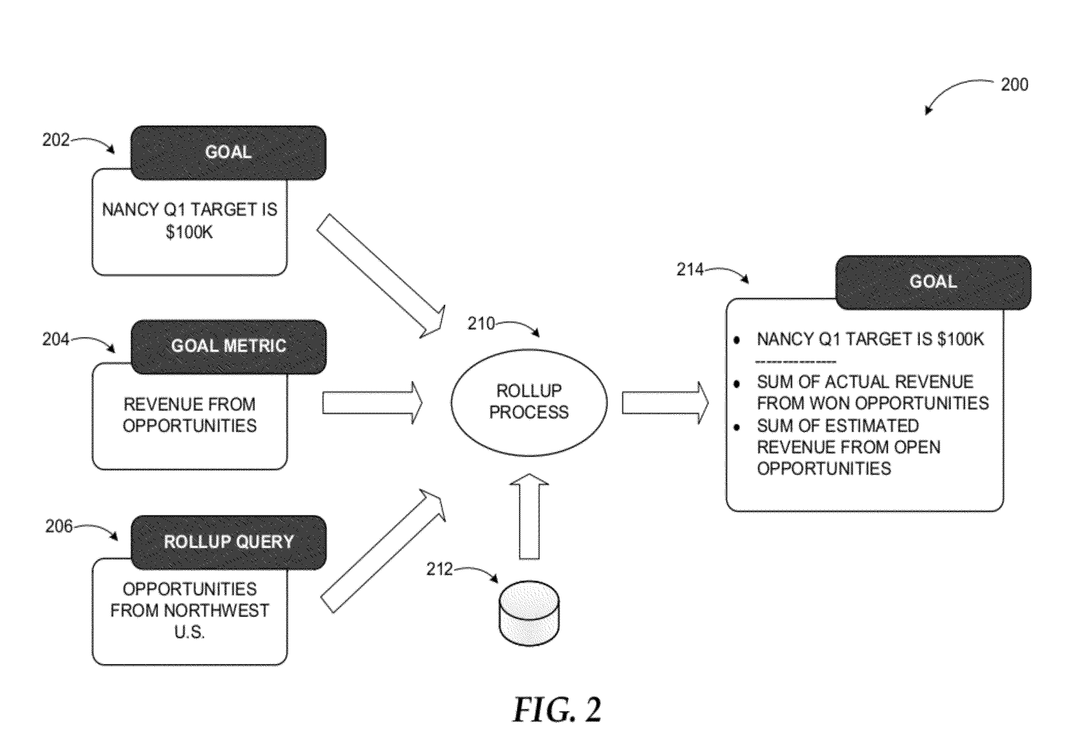

FIG. 2 illustrates an example rollup process according to some embodiments. As shown in diagram 200, example goal 202 is “Nancy's Q1 target is $100 k” in a sales type organization. Example goal metric 204 may be “revenue from opportunities” and example rollup query 206 may be “opportunities from Northwest U.S.”

Rollup process 210 executed by the CRM system may take the source entity details of the rollup field based on the metric attached to a goal (goal metric 204), and then take the filtering criteria specified as rollup queries (e.g., rollup query 206). With this information, rollup process 210 may calculate the actuals for the goal and sum the actuals coming from child goals (e.g., from data store 212) and derive the result to the current goal 214. Current goal 214 in the example scenario of diagram 200 may include the sum of revenue from won opportunities and the sum of revenue from open opportunities.

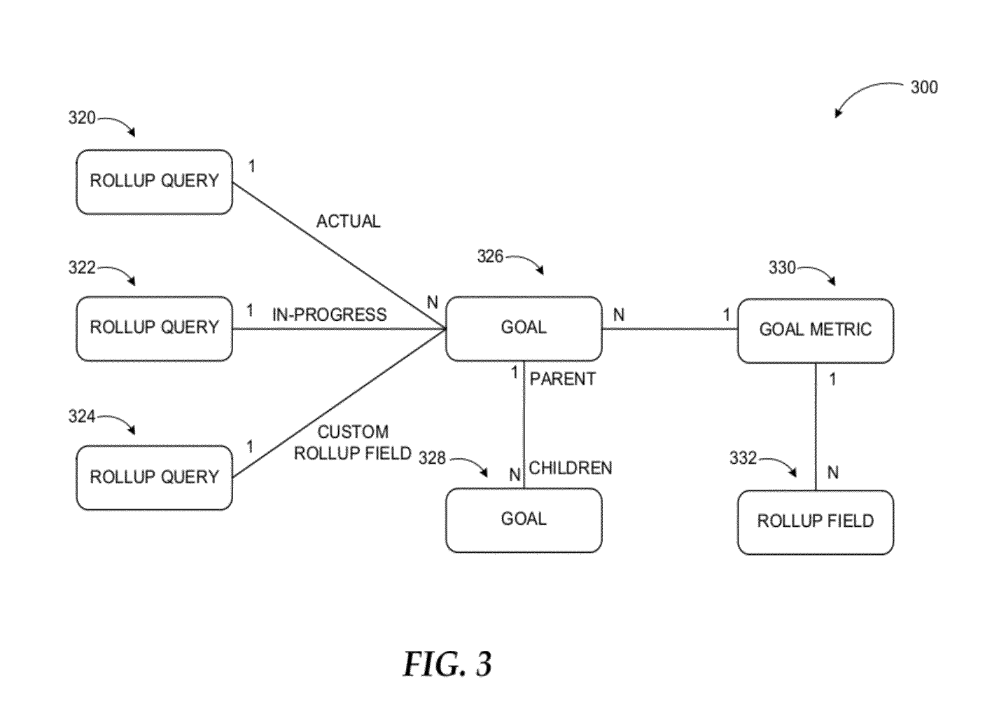

FIG. 3 is a block diagram illustrating an example rollup process according to embodiments. As discussed above, a goal is a collection of target amount, timeline, and a goal owner. A goal metric defines a type of the goal and a source entity to roll up the actuals. For example, a revenue goal metric may be of money type and actuals may be rolled up from opportunities. A rollup query may be a custom query for summarizing source records.

Diagram 300 illustrates an example rollup process, where the rollup query is replicated for money, integer, and decimal metric types (320, 322, and 324). A user defining the metric for his/her organization may choose one or more of the attributes for the metrics. The names of the metric attributes may be predefined by the system for each metric type.

According to some embodiments, the money rollup types may be called Actual (Money), In-progress (Money) and Custom Rollup Field (Money). Integer rollup types may be called Actual (Integer), In-progress (Integer) and Custom Rollup Field (Integer). Money rollup types may be called Actual (Decimal), In-progress (Decimal) and Custom Rollup Field (Decimal).

The rollup fields 332 are child records of goal metric 330. The rollup fields (Actual/Estimated/In-Progress) along with rollup queries 320, 322, and 324 enable the system to determine where to obtain relevant data. Child goal(s) 328 may rollup to goal 326. Based on the metric type, the goal form may change so that the user can add target and rollup queries in the relevant type, and the system may compute the actuals in the same type and present to the user for tracking purposes.

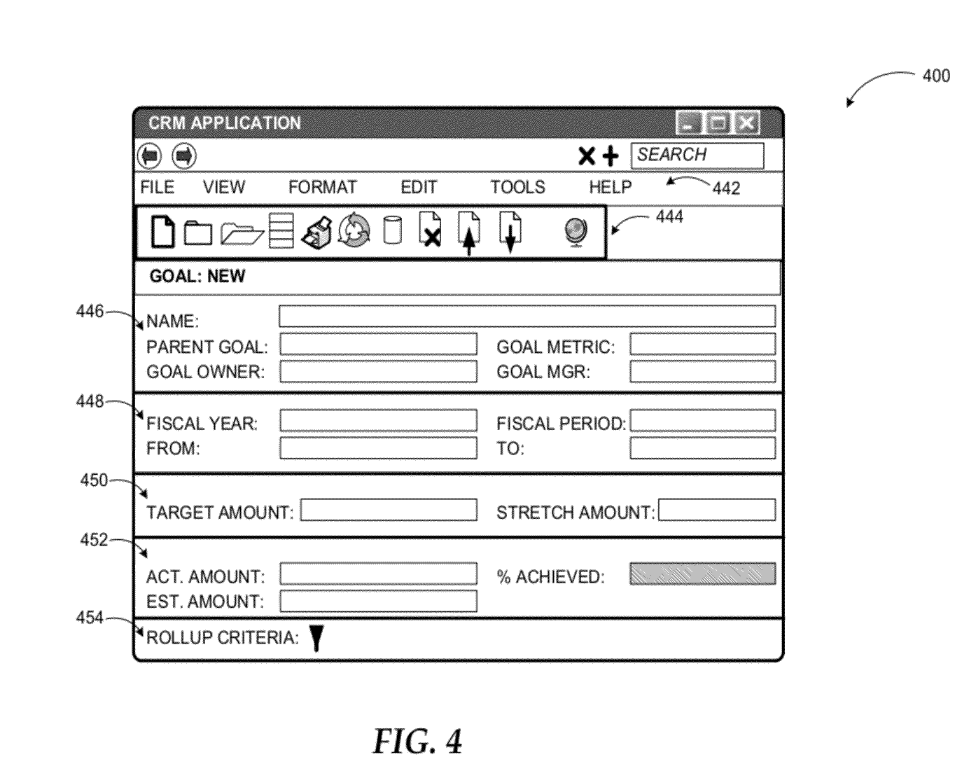

FIG. 4 is a screenshot of an example user interface for specifying parameters in a CRM system according to embodiments. A user interface for a CRM system may be provided by a locally installed full-featured application (rich client) or a “thin client” such as a browser that enables access to a CRM service with a majority of the features provided by the CRM service.

As illustrated on screenshot 400, the user interface may include standard elements such as drop down menus 442, icons 444 representing control elements (or commands). In a system according to embodiments, the user interface may identify the current goal and enable a user to specify a name for the goal, a parent goal (if the current goal is a child goal), a goal metric, a goal owner, and a goal manager in section 446. The user may be enabled to specify these variables by entering them into a textbox, selecting from a drop down menu, or similar methods. Additional capabilities may be provided such as search-enabled text boxes.

In section 448, the user may be enabled to specify a fiscal year and a fiscal period (e.g., a quarter, month, etc.) be selecting them from a calendar, entering input into a textbox, or by selecting beginning and end dates. A target amount and a stretch amount may be specified in section 450. The amounts may be specified in currency, as integer, or as decimal. Section 452 of the user interface may display actual and estimated amounts, and percentage achievement. Rollup criteria may be specified or modified through another interface activated in section 454.

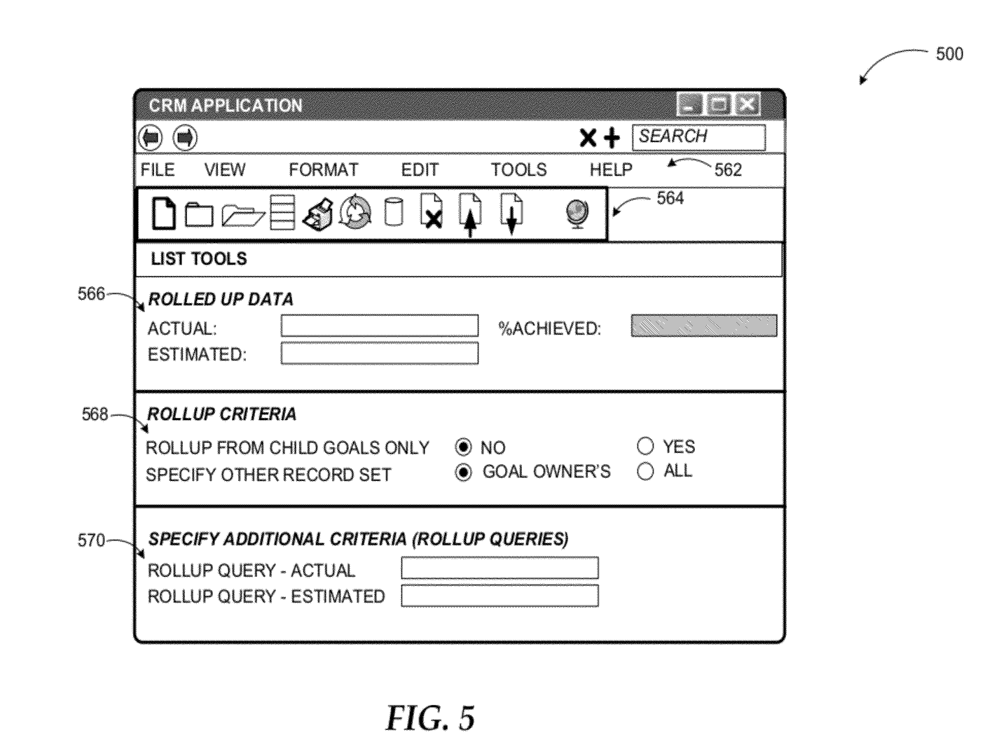

FIG. 5 is a screenshot of another example user interface for specifying parameters in a CRM system. Screenshot 500 illustrates a user interface that may be activated through section 454 of the user interface in FIG. 4 and enable a user to specify/modify rollup criteria. The user interface in screenshot 500 may also include standard elements such as drop down menus 562, icons 564 representing control elements (or commands).

In section 566, actual and estimated amounts along with percentage achievement may be displayed. The actual and estimated amounts may be displayed in a type that is defined in metric metadata (e.g., dollar amount). Section 568 may enable the user to select whether the rollup is to be performed from child goals only or not and if additional criteria are selected whether goal owner's records are to be used or all goals. Section 570 may enable the user to specify additional criteria by entering actual and estimated amounts for rollup queries. The type of amounts (e.g., money, integer, decimal, etc.) may be determined from the metric.

The user interface in screenshot 500 may include additional information such as a listing of the child goals with links that activate additional user interfaces for editing those goals. Other control elements, information, and input mechanisms may also be employed to enable users to specify and/or modify other parameters associated with the rollup process.

The example systems and user interfaces in FIG. 1 through 5 have been described with specific components, processes, user interface elements, and interactions. Embodiments are not limited to systems according to these example configurations. A CRM system for metric driven behavior and presentation of goals may be implemented in configurations employing fewer or additional components and performing other tasks. Furthermore, specific protocols and/or interfaces may be implemented in a similar manner using the principles described herein.

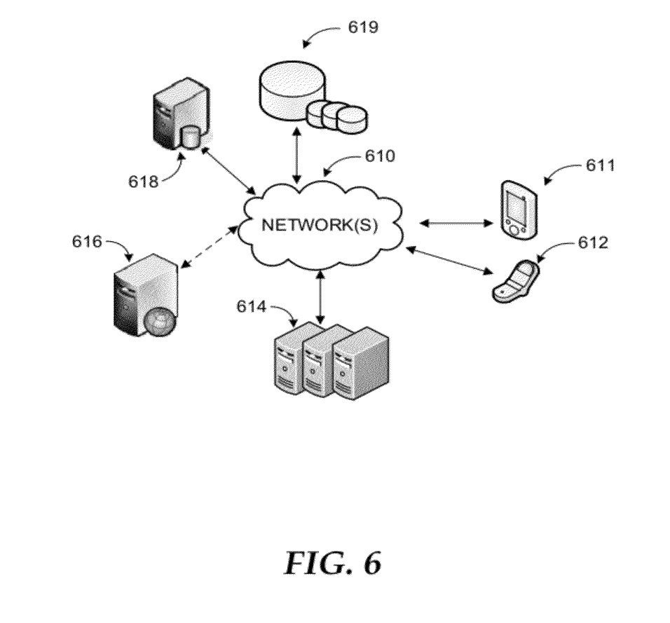

FIG. 6 is an example networked environment, where embodiments may be implemented. Metric driven behavior and presentation of goals may be implemented via software executed over one or more servers 616 such as a hosted CRM service. The platform may communicate with client applications on individual computing devices such as a handheld computing device 611 and smart phone 612 ('client devices') through network(s) 610.

Client applications executed on any of the client devices 611-612 may facilitate interaction with the CRM service executed by servers 614, or on individual server 616. An application executed on one of the servers may provide a user interface for specifying parameters associated with the CRM system computations as shown in FIGS. 4 and 5. Goals may be computed based on different dimensions modeled as a rollup query and metadata present in metric definition. The actuals may then be rolled up the hierarchy. The goals may be represented in different dimensions using the rollup queries. The application may retrieve relevant data from data store(s) 619 directly or through database server 618, and provide requested services (e.g. document editing) to the user(s) through client devices 611-612.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to implement a platform providing metric driven behavior and presentation of goals in a CRM system. Furthermore, the networked environments discussed in FIG. 6 are for illustration purposes only. Embodiments are not limited to the example applications, modules, or processes.

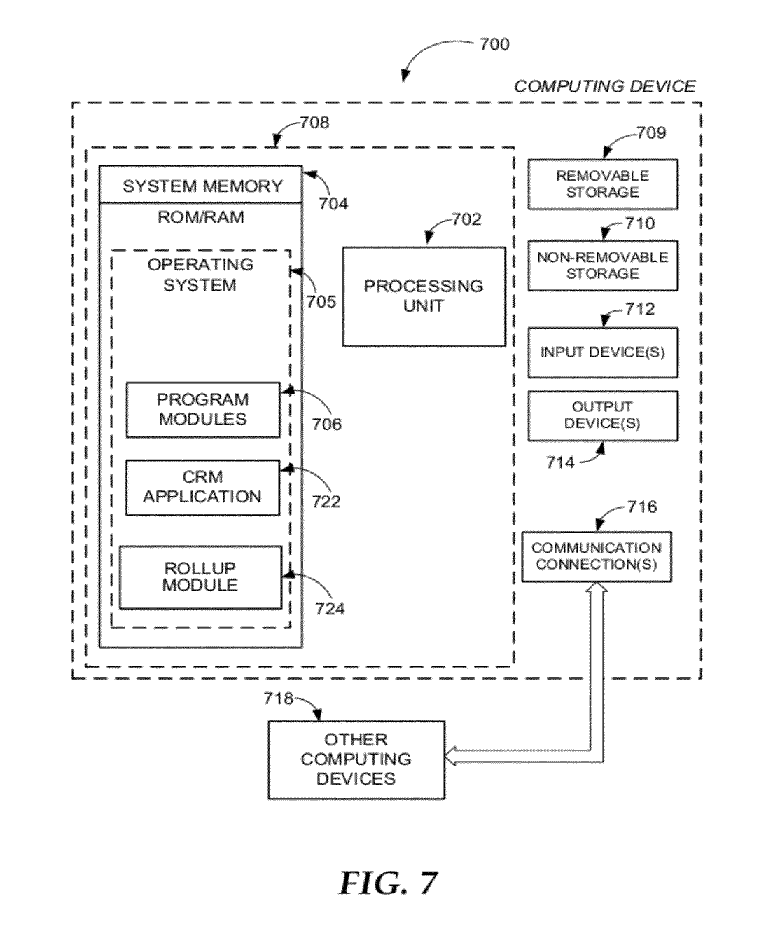

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as computing device 700. In a basic configuration, computing device 700 may be any computing device executing a CRM application according to embodiments and include at least one processing unit 702 and system memory 704. Computing device 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of the platform, such as the WINDOWS® operating systems from MICROSOFT CORPORATION of Redmond, Wash.

The system memory 704 may also include one or more software applications such as program modules 706, CRM application 722, and rollup module 724. CRM application 722 may provide a variety of customer relationship management related services including, but not limited to, tracking performance metrics, computing goals, presenting reports, and comparable ones.

Rollup module 724 or another module in conjunction with CRM application 722 may adjust behavior and presentation of goals based on metrics enabling computation of the goals based on different dimensions modeled as a rollup query and metadata present in metric definition. CRM application 722 and rollup module 724 may be separate applications or integrated modules of a hosted service. This basic configuration is illustrated in FIG. 7 by those components within dashed line 708.

Computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 700. Any such computer readable storage media may be part of computing device 700. Computing device 700 may also have input device(s) 712 such as keyboard, mouse, pen, voice input device, touch input device, and comparable input devices. Output device(s) 714 such as a display, speakers, printer, and other types of output devices may also be included. These devices are well known in the art and need not be discussed at length here.

Computing device 700 may also contain communication connections 716 that allow the device to communicate with other devices 718, such as over a wired or wireless network in a distributed computing environment, a satellite link, a cellular link, a short range network, and comparable mechanisms. Other devices 718 may include computer device(s) that execute communication applications, web servers, and comparable devices. Communication connection(s) 716 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

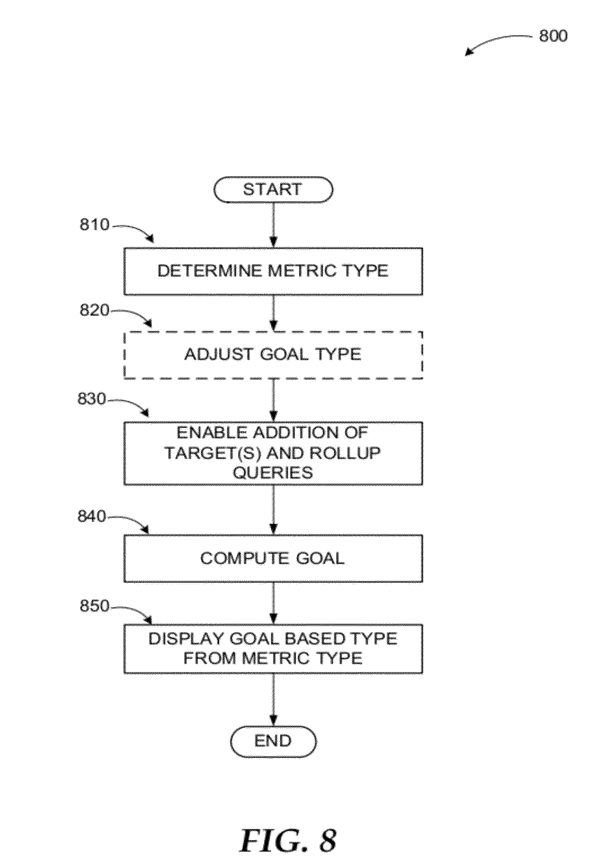

FIG. 8 illustrates a logic flow diagram for process 800 of adjusting behavior and presentation of goals based on metrics in a CRM system according to embodiments. Process 800 may be implemented on a computing device or similar electronic device capable of executing instructions through a processor.

Process 800 begins with operation 810, where a goal metric type is determined from the metadata of the metric. Depending on the processes being monitored, the type of the metric may be monetary, integer, decimal, and similar ones. If the type of the metric is different from a current goal, the goal type may be adjusted at optional operation 820.

At operation 830, a user may be enabled to add one or more targets and rollup queries of the determined type through a user interface that dynamically sets the type for value input. At operation 840, the system may compute the goal using the entered/existing values with the determined type. Any feedback displays such as percent achievement may also be automatically adjusted on the user interface. The computed goal and any additional related information (e.g., graphs, links to child goals, etc.) may be displayed at operation 850 using the metric type determined from the metric metadata.

The operations included in process 800 are for illustration purposes. Metric driven behavior and presentation of goals in a CRM system may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method for metric driven computation and presentation of goals in a Customer Relationship Management (CRM) system, comprising:
determining a type of a metric to be used in a rollup process;
if a type of a current goal is different from the determined metric type, adjusting the current goal type based on the determined metric type;
enabling a user to add at least one from a set of a target and a rollup query of the same type as the metric; and
computing an updated goal executing the rollup process.

2. The method of claim 1, further comprising:
displaying the updated goal employing the type determined from the metric.

3. The method of claim 1, wherein the type of the metric is determined from metric metadata.

4. The method of claim 1, wherein the type includes one of monetary, integer, decimal, and count.

5. The method of claim 1, wherein the current goal defines at least one from a set of: a target amount, a time period, a goal owner, a child goal, and a parent goal.

6. The method of claim 5, wherein the current goal further includes at least one from a set of: actuals and estimates to be rolled up against the target.

7. The method of claim 1, further comprising:
computing the updated goal by rolling up using one or more rollup queries and one or more child goals.

8. The method of claim 7, wherein the rollup queries include one from a set of: actual, in-progress, and custom rollup fields.

9. The method of claim 1, further comprising:
adjusting displayed types of parameters to be specified by the user on a user interface of the CRM system based on the determined metric type.

10. The method of claim 1, further comprising:
enabling the user to select one or more rollup fields as attributes for each goal metric.

11. A computing device capable of metric driven computation and presentation of goals in a Customer Relationship Management (CRM) system, the computing device comprising:
a display configured to display a user interface associated with the CRM system;
a memory configured to store instructions; and
a processor coupled to the memory for executing the stored instructions, the processor configured to:
determine a type of a metric to be used in a rollup process;
if a type of a current goal is different from the determined metric type, adjust the current goal type based on the determined metric type;
enable a user to add at least one from a set of a target and a rollup query of the same type as the metric through the displayed user interface;
compute an updated goal executing the rollup process; and
display the updated goal employing the type determined from the metric on the user interface.

12. The computing device of claim 11, wherein the metric defines a goal type and rollup rules for actuals and estimates.

13. The computing device of claim 11, wherein the rollup queries include one from a set of: actual, in-progress, and custom rollup fields with the rollup fields being one of monetary, integer, decimal, and count type fields.

14. The computing device of claim 11, wherein the processor is further configured to:
enable the user to specify and modify through the user interface at least one from a set of a name of the current goal, a parent for the current goal, the metric, an owner of the current goal, a fiscal period, a target amount, a stretch amount, an actual amount, and an estimated amount through at least one from a set of: a textbox, a drop down menu, and a selection.

15. The computing device of claim 11, wherein the user interface is further configured to display a percent achieved amount according to the metric type.

16. The computing device of claim 11, wherein the user interface is further configured to enable the user to specify additional rollup queries and input actual and estimated values for the rolled up data according to the metric type.

17. A computer-readable storage medium with instructions stored thereon for metric driven computation and presentation of goals in a Customer Relationship Management (CRM) system, the instructions comprising:
determining a type of a metric to be used in a rollup process from metadata associated with a goal metric;
if a type of a current goal is different from the determined metric type, adjusting a form of the current goal type based on the determined metric type such that a user is enabled to add a target amount and a rollup query according to the determined metric type;
computing an updated goal executing the rollup process with actuals and estimates according to the determined metric type; and
displaying at least one from a set of: the updated goal, employed rollup criteria, child goals, and the goal metric according to the determined metric type.

18. The computer-readable medium of claim 17, wherein the instructions further comprise:
enabling the user to select between using child goal rollups and specifying additional rollup queries.

19. The computer-readable medium of claim 18, wherein the current goal is a collection of a target amount, a timeline for achieving the goal, and a goal owner, and the goal metric defines a type of the current goal and a source entity to roll up actuals.

20. The computer-readable medium of claim 17, wherein the user is enabled to add a target amount and a rollup query through a user interface managed by one of: a thin client application accessing a hosted CRM service and a locally installed rich client application.
